(19) United States
(12) Patent Application Publication
(10) Pub. No.: US 2010/0272856 A1
(43) Pub. Date: Oct. 28, 2010

(54) METHOD FOR PREPARING PROCESSED VEGETABLE FOODSTUFFS AND PROCESSED VEGETABLE FOODSTUFFS

(75) Inventors: Fumio NODA, Nanao-shi (JP); Ryota OHARA, Nanao-shi (JP); Masahiro HINOKI, Nanao-shi (JP); Isamu YOSHINO, Nanao-shi (JP); Koichi UEDA, Nanao-shi (JP); Minoru NODA, Nanao-shi (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(73) Assignee: SUGIYO CO., LTD., Ishikawa (JP)

(21) Appl. No.: 12/759,726

(22) Filed: Apr. 14, 2010

(30) Foreign Application Priority Data
Apr. 27, 2009 (JP) 2009-108527

(51) Int. Cl. A23B 7/154; A23L 1/212

(52) U.S. Cl. 426/50; 426/49; 426/615

(57) ABSTRACT

A method for preparing processed vegetable foodstuffs according to the present invention includes a step of finely cutting vegetables by physical processing in the presence of enzymes, in which the enzymes are a plant tissue separating enzyme containing substance and a plant tissue degrading enzyme containing substance, and the vegetables are physically processed under a reduced pressure atmosphere of 100 Torr or less.

This nonprovisional application claims priority under 35 U.S.C. §119(a) to Patent Application No. 2009-108527 filed in Japan on Apr. 27, 2009, the entire contents of which are hereby incorporated by reference.

### BACKGROUND OF THE INVENTION

1. Field of the Invention

The present invention relates to a method for preparing processed vegetable foodstuffs and processed vegetable foodstuffs, and more particularly to a method for preparing processed vegetable foodstuffs and processed vegetable foodstuffs which make efficient use of vegetables (in particular, substandard vegetables and process residues which are typically disposed of), including root crops such as carrot, fruit vegetables such as pumpkin, potatoes such as white potato and sweet potato, and green vegetables such as cabbage and napa cabbage.

2. Description of the Related Art

Through enzyme processing of vegetables, it becomes possible to prepare processed vegetable foodstuffs as a paste or an extract. The obtained paste material is used in food and chemical industries. Making vegetables into a paste enables an effective use of substandard vegetables and process residues which are conventionally disposed of.

In addition, through the pasting of materials with a low processing capacity, such materials can be used for broader purposes. Further, the microparticulation of vegetables is expected to result in an increase of the absorption efficiency of the vegetables in the body.

Such processed vegetable foodstuffs are prepared by methods such as physical crushing, and chemical or biochemical degradation.

Substandard vegetables and process residues of vegetables contain fibers that are very tough. Thus, they leave a feeling of roughness on the tongue if processed only by physical processing. This makes their taste and organoleptic feel poor, and also makes their use limited. Furthermore, biochemical processing with enzymes alone prolongs processing time, which is impractical.

Japanese Laid-Open Publication No. 6-105661 describes a way of grinding vegetables to a particle diameter of 300 μm to 1000 μm and subsequently performing enzyme processing on them to prepare unicellular food.

The size of plant cells obtained by this method is, however, about 40 μm, and the size of particles is limited in unicellular food. Unicellular food with the particle diameter of 40 μm has a problem of leaving a feeling of roughness to the tongue.

Reference 1: Japanese Laid-Open Publication No. 6-105661

### SUMMARY OF THE INVENTION

The objective of the present invention is to provide: a method for preparing processed vegetable foodstuffs with an excellent feel on the tongue in a short period of time; and processed vegetable foodstuffs prepared thereby.

In order to achieve the above objective, the present invention provides, for example, the following means.

A method for preparing processed vegetable foodstuffs according to the present invention includes a step of finely cutting vegetables through physical processing in the presence of enzymes, wherein the enzymes include a plant tissue separating enzyme containing substance and a plant tissue degrading enzyme containing substance, and the vegetables are physically processed under a reduced pressure atmosphere of 100 Torr or less.

In the method for preparing processed vegetable foodstuffs according to the present invention, the physical processing is fine cutting with a high-speed cutter mixer.

In the method for preparing processed vegetable foodstuffs according to the present invention, the plant tissue separating enzyme containing substance is at least one selected from the group consisting of a microorganic bacterial cell, a microorganic bacterial cell extract, an animal tissue, an animal tissue extract and a pectinase formulation; and the plant tissue degrading enzyme containing substance is at least one selected from the group consisting of a microorganic bacterial cell, a microorganic bacterial cell extract, an animal tissue, an animal tissue extract and a cellulase formulation.

In the method for preparing processed vegetable foodstuffs according to the present invention, an average particle diameter of the processed vegetable foodstuffs is 30 μm or less.

Processed vegetable foodstuffs according to the present invention are obtained by the method according to the present invention and have an average particle diameter of 30 μm or less.

According to the present invention, vegetables are cut into fine pieces and mixed with enzymes for an enzyme reaction so that such solid vegetables, including substandard vegetables and process residues thereof, have more surface area in contact with the enzymes. That is, through the provision of a mechanical shearing effect of the fine cutting, the vegetables have increased surface contact area, and the enzymes react to the fine particle surfaces of the vegetables. Owing to such synergy, fine particles can be processed with the enzymes in a short period of time and in an effective manner. Further, according to the present invention, the processing is performed under a reduced pressure atmosphere of 100 Torr or less, so that the quality of vegetables is stabilized and the enzyme effect is promoted. As enzymes, a plant tissue separating enzyme containing substance and a plant tissue degrading enzyme containing substance are used, so that solid vegetables including substandard vegetables and process residues can be cut finely in a short period of time and homogeneous processed vegetable foodstuffs can be obtained.

### DESCRIPTION OF THE PREFERRED EMBODIMENTS

Hereinafter, the present invention will be described in detail.

In the present invention, a plant tissue separating enzyme containing substance and a plant tissue degrading enzyme containing substance are used as the source of enzymes. In physical processing of vegetables in the presence of the enzymes, the vegetables are cut finely under a reduced pressure atmosphere of 100 Torr or less.

The types of vegetables used herein are not limited. For example, included are root crops such as carrot, fruit vegetables such as pumpkin, potatoes such as white potato and sweet potato, green vegetables such as cabbage and napa cabbage. In addition, these vegetables also include their substandard vegetables and process residues.

By adding a mechanical fine cutting process to the vegetables during an enzyme reaction therewith, the surface area of the solid vegetables increases, thereby increasing the contacting area with the enzymes.

Further, by performing physical processing and biochemical processing under a reduced pressure atmosphere, the enzymes closely adhere to the vegetable substrate, thereby effectively promoting the enzyme reaction. In addition, the enzyme processing can be performed at a low temperature, which makes it possible to cut vegetables finely without loss of aroma and taste.

In the physical processing described above, a known fine cutter or pulverizer capable of finely cutting vegetables can be used. For example, it is preferable to use a high-speed cutter mixer.

A high-speed cutter mixer refers to a device for fine cutting by high-speed rotation of a bladed axis. For example, the ball cutter by Yanagiya Machinery Co. Ltd. and the Stephan cutter by Stephan can be used.

The plant tissue separating enzyme containing substance used in the present invention includes, for example, an aspergillus niger cell homogenate and a pectinase formulation, such as Pectinase G “Amano”. Any plant tissue separating enzyme containing substance can be used.

Further, the plant tissue degrading enzyme containing substance used in the present invention includes a bacterium extract such as a trichoderma viride cell homogenate, an animal tissue extract such as an internal organ homogenate of Euhadra subnimbosa, and a cellulase formulation such as Cellulase“Onozuka3S”. Any plant tissue degrading enzyme containing substance can be used.

These plant tissue separating enzyme containing substances and plant tissue degrading enzyme containing substances are used in combination in the present invention. Regarding the amount of the enzyme containing substances used, the plant tissue degrading enzyme containing substance is preferably 0.05 to 5 percent by weight with respect to the vegetables, and the plant tissue separating enzyme containing substance is preferably 0.01 to 1 percent by weight with respect to the vegetables. More preferably, the plant tissue degrading enzyme containing substance is 0.1 to 1 percent by weight with respect to the vegetables, and the plant tissue separating enzyme containing substance is 0.02 to 0.5 percent by weight with respect to the vegetables.

When the amount of the plant tissue degrading enzyme containing substance used is less than 0.05 percent by weight with respect to the vegetables, the efficiency of the enzyme reaction tends to decrease. When the amount of the plant tissue separating enzyme containing substance used is less than 0.01 percent by weight with respect to the vegetables, the efficiency of the enzyme reaction tends to decrease.

The temperature is preferably between 18 and 60° C. during the physical processing of the vegetables in the presence of the above described enzymes. The temperature is more preferably between 30 and 50° C. The processing time is preferably between 10 and 180 minutes, and more preferably between 30 to 60 minutes.

In the present invention, the physical processing is performed on the vegetables under a reduced pressure atmosphere as described above. The processing is performed under a reduced pressure atmosphere of 100 Torr or less. The reduced pressure atmosphere is preferably between 10 and 50 Torr, and more preferably between 10 and 20 Torr.

When the reduced pressure condition exceeds 100 Torr during the physical processing of the vegetables, the efficiency of the enzyme reaction will decrease as described above.

As described above, by performing the physical processing and biochemical processing simultaneously under a reduced pressure atmosphere, plant cells can be destroyed effectively and processed vegetable foodstuffs can be obtained with particles smaller than cell size.

Processed vegetable foodstuffs obtained thereby are preferably in the form of a paste or an extract, and the average particle diameter is preferably 30 μm or less, more preferably 20 μm or less. When the average particle diameter exceeds 30 μm, the feel on the tongue of the processed vegetable foodstuffs will decline.

The processed vegetable foodstuffs according to the present invention can be used in food and chemical industries. In such cases, the additive amount of the processed vegetable foodstuffs is normally 1 to 40 percent by weight, and preferably 5 to 20 percent by weight. The additive amount can be varied as appropriate in accordance with various kinds of use.

Foods include, for example, Japanese-style confectionery, Western-style confectionery, sweets such as jelly, bread, azuki-bean jelly, noodles (udon noodle, Chinese noodles, buckwheat noodles, fried noodles, pasta and the like), seaweed-containing fish cake, jam, dressing, seasonings such as source, gratin, stew, soups, spaghetti, hamburger patty, pizza, croquette, meals served over rice in a bowl, fried rice, rice gruel, Japanese hotchpotch, boiled food, stir-fried food, deep-fried food and the like.

Hereinafter, the present invention will be specifically described with reference to examples. Note that the present invention is not limited by the examples. In the following examples, the term “percent” all means “percent by weight”.

The average particle diameter of particles contained in processed vegetable foodstuffs was measured in accordance with the following method.

The processed vegetable foodstuffs with enzyme processing were measured for particle size distribution using a dry particle size distribution device (HORIBA LA-920). The median particle diameter was calculated to determine the particle size distribution.

### Example 1

Five kilograms of raw carrots were put into a high-speed cutter mixer in which warm water (30° C.) was circulating in a jacket. Ten grams of Pectinase G “Amano” and twenty-five grams of Cellulase “Onozuka 3S” were dissolved in 300 ml of 10% citric acid and the mixture was added to the high-speed cutter mixer. Cutting the carrot finely, the processing was performed for 30 minutes under a reduced pressure atmosphere of 100 Torr.

One kilogram of thus obtained processed vegetable foodstuffs was vacuum-packed and was heated to be sterilized for 15 minutes at 90° C.

### Example 2

Carrots were processed by fine cutting similarly to Example 1, except that the processing was performed under a reduced pressure atmosphere of 10 Torr. One kilogram of thus obtained processed vegetable foodstuffs was vacuum-packed and was heated to be sterilized for 15 minutes at 90° C.

### Comparative Example 1

Carrots were processed by fine cutting similarly to Example 1, except that the processing was performed under a reduced pressure atmosphere of 700 Torr. One kilogram of thus obtained processed vegetable foodstuffs was vacuum-packed and was heated to be sterilized for 15 minutes at 90° C.

### Comparative Example 2

Carrots were processed by fine cutting similarly to Example 1, except that the processing was performed under a reduced pressure atmosphere of 150 Torr. One kilogram of thus obtained processed vegetable foodstuffs was vacuum-packed and was heated to be sterilized for 15 minutes at 90° C.

Next, the packages of the processed vegetable foodstuffs obtained in the above-described Examples 1 and 2 as well as Comparative Examples 1 and 2 were opened for the following food texture taste test.

(Effect of Particle Diameter)

This food texture taste test was conducted by 10 participants, who sampled the processed vegetable foodstuffs. The participants then scored +1 point for the processed vegetable foodstuffs that were pleasant to the tongue, and scored −1 point for the processed vegetable foodstuffs that were unpleasant to the tongue. Table 1 illustrates the result of the sampling with the average points of the 10 participants.

TABLE 1

| Effect of Particle Diameter | | |
|---|---|---|
| | Particle Diameter | Feel on the Tongue |

| | | | |
|---|---|---|---|
| Example 1 | 27 | μm | 0.4 |
| Example 2 | 9 | μm | 0.8 |
| Comparative | 97 | μm | −0.8 |
| Example 1 | | | |
| Comparative | 56 | μm | −0.4 |
| Example 2 | | | |

(Effect of the Degree of Vacuum)

This food texture taste test was conducted by 10 participants, who sampled the processed vegetable foodstuffs. The participants then scored +1 point for the processed vegetable foodstuffs that were pleasant to the tongue, and scored −1 point for the processed vegetable foodstuffs that were unpleasant to the tongue. Table 2 illustrates the result of the sampling with the average points of the 10 participants.

TABLE 1

| Effect of the Degree of Vacuum | | |
|---|---|---|
| | Degree of Vacuum | Feel on the Tongue |

| | | | |
|---|---|---|---|
| Example 1 | 100 | Torr | 0.4 |
| Example 2 | 10 | Torr | 0.8 |
| Comparative | 700 | Torr | −0.8 |
| Example 1 | | | |
| Comparative | 150 | Torr | −0.4 |
| Example 2 | | | |

From the above results, it is understood that the efficiency of the enzyme reaction increases with physical processing of vegetables under the condition of a reduced pressure atmosphere of 100 Torr; resulting in processed vegetable foodstuffs with a smoother and more pleasant feel on the tongue.

### INDUSTRIAL APPLICABILITY

The processed vegetable foodstuffs obtained by the present invention can be used as additions to various foods and chemical products.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A method for preparing processed vegetable foodstuffs, comprising a step of finely cutting vegetables through physical processing in the presence of enzymes,
wherein the enzymes include a plant tissue separating enzyme containing substance and a plant tissue degrading enzyme containing substance; and
the vegetables are physically processed under a reduced pressure atmosphere of 100 Torr or less.

2. The method for preparing processed vegetable foodstuffs according to claim 1, wherein the physical processing is fine cutting with a high-speed cutter mixer.

3. The method for preparing processed vegetable foodstuffs according to claim 1, wherein:
the plant tissue separating enzyme containing substance is at least one selected from the group consisting of a microorganic bacterial cell, a microorganic bacterial cell extract, an animal tissue, an animal tissue extract and a pectinase formulation; and
the plant tissue degrading enzyme containing substance is at least one selected from the group consisting of a microorganic bacterial cell, a microorganic bacterial cell extract, an animal tissue, an animal tissue extract and a cellulase formulation.

4. The method for preparing processed vegetable foodstuffs according to claim 1, wherein an average particle diameter of the processed vegetable foodstuffs is 30 μm or less.

5. Processed vegetable foodstuffs obtained by the method according to claim 1 and having an average particle diameter of 30 μm or less.
